(19) United States
(12) Patent Application Publication
(10) Pub. No.: US 2014/0235388 A1
(43) Pub. Date: Aug. 21, 2014

(54) MECHANISM FOR ADJUSTING TENSION OF BELT OF A BICYCLE

(71) Applicant: WEN-PIN CHANG, Taichung (TW)

(72) Inventor: WEN-PIN CHANG, Taichung (TW)

(21) Appl. No.: 13/772,331

(22) Filed: Feb. 21, 2013

(51) Int. Cl. F16H 7/12

(52) U.S. Cl. CPC F16H 7/12
USPC 474/135

(57) ABSTRACT

A mechanism for adjusting tension of a belt of a bicycle includes a link pivotably connected between an arm and a frame. The arm has a tension adjustment bolt connected to one end thereof and the frame has a guide wheel connected thereto. An extension spring is between the arm and the frame. The link, the arm, the extension spring and the frame form a four-link mechanism is cooperated with the extension spring to allow the guide wheel to consistently press the belt to keep the belt with a proper tension. When the bolt is unscrewed, the whole mechanism is moved downward from the belt so that the replacement of the rear wheel and the belt is easy and convenient.

### FIELD OF THE INVENTION

The present invention relates to a tension adjustment mechanism, and more particularly, to a belt tension adjustment mechanism of a bicycle.

### BACKGROUND OF THE INVENTION

The conventional mechanism for adjusting tension of a belt of a bicycle is disclosed in FIG. 1 and generally comprises a rear dropout 901 with a horizontal slot and the axle 911 of the rear hub is movably located in the horizontal slot. A locking member 921 is cooperated with a U-shaped pad 923 and connected to the end of the axle 911. A nut 922 is threadedly connected to the bolt 921 and able to adjust the position of the axle 911 to achieve the purpose of adjustment of tension for the belt. However, the structure of the mechanism is complicated and the user has to adjust the tension of the belt several times by way of try and error by adjusting different bolts of the mechanism. When replacing a new tire, a new belt or even when the belt is affected by the temperature, the complicated steps have to be proceeded again, and this is a burden for the users.

The complication of the adjustment steps and the complicated structure of the conventional mechanism are difficult for the users to adjust the tension of the belt. This is one of the reasons that the belt-transmission bicycles cannot be accepted by the users.

The present invention intends to provide a mechanism for adjusting tension of a belt of a bicycle and the adjustment can be easily completed by one bolt. The multi-link mechanism and the extension spring allow the guide wheel to consistently press the belt so as to keep the belt with a proper tension. The belt lower portion of the belt is not loosened during operation and the belt does not skip from the teeth of the gear of the bicycle. When the bolt is unscrewed, the whole mechanism is removed from the belt so that the replacement of the rear wheel and the belt is easy and convenient.

### SUMMARY OF THE INVENTION

The present invention relates to a mechanism for adjusting tension of a belt of a bicycle and comprises a link which is pivotably connected between an arm and a frame. The arm has a tension adjustment bolt connected to one end thereof and the frame has a guide wheel connected thereto. An extension spring is connected between the arm and the frame.

The primary object of the present invention is to provide a mechanism for adjusting tension of a belt of a bicycle, the mechanism is easily connected to the dropouts of the bicycle and the tension of the belt can be easily adjusted by using one bolt.

Another object of the present invention is to provide a mechanism for adjusting tension of a belt of a bicycle, wherein the link, the arm, the extension spring and the frame form a four-link mechanism which is cooperated with the extension spring to allow the guide wheel to consistently press the belt to keep the belt with a proper tension.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the conventional belt adjustment mechanism with a horizontal slot;

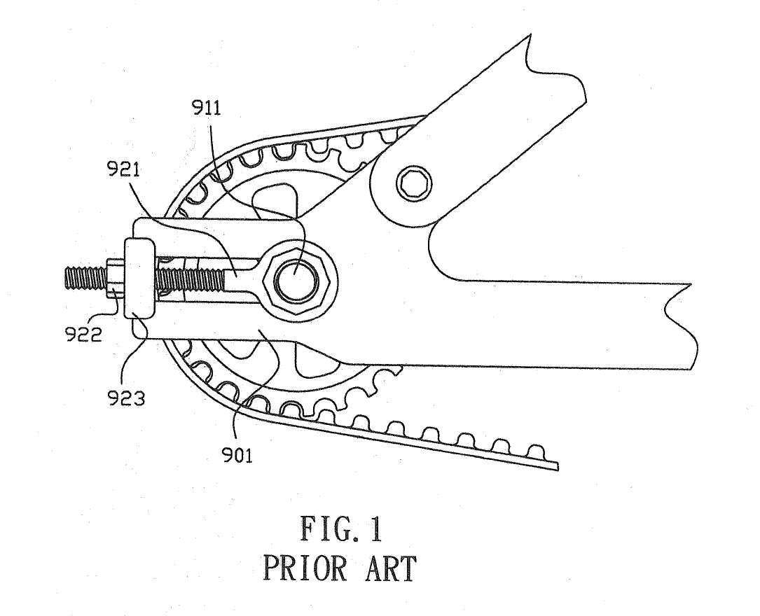

FIG. 2 is a perspective view to show the mechanism for adjusting tension of a belt of the present invention;

FIG. 3 is an exploded view to show the mechanism for adjusting tension of a belt of the present invention;

FIG. 4 shows that the mechanism for adjusting tension of a belt of the present invention is installed to a bicycle, and

FIG. 5 shows that guide wheel of the mechanism for adjusting tension of a belt of the present invention presses onto the belt.

### DETAILED DESCRIPTION OF THE PREFERRED EMBODIMENT

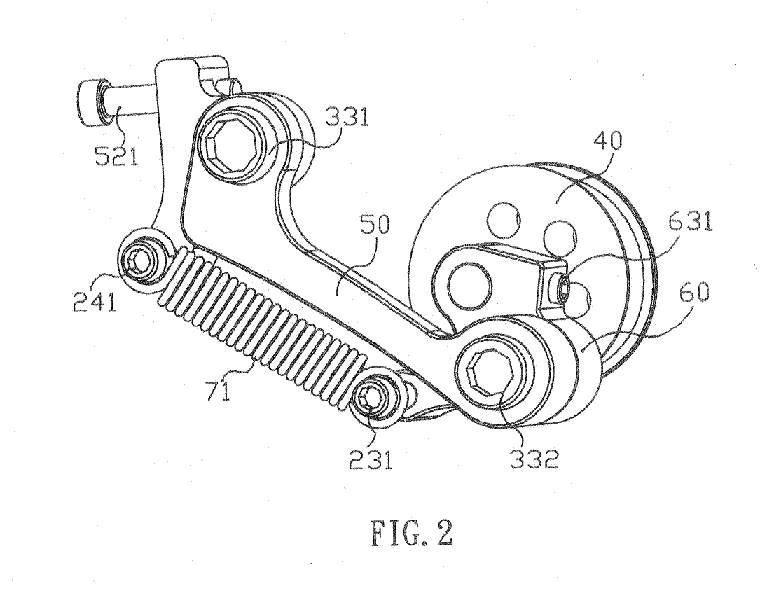

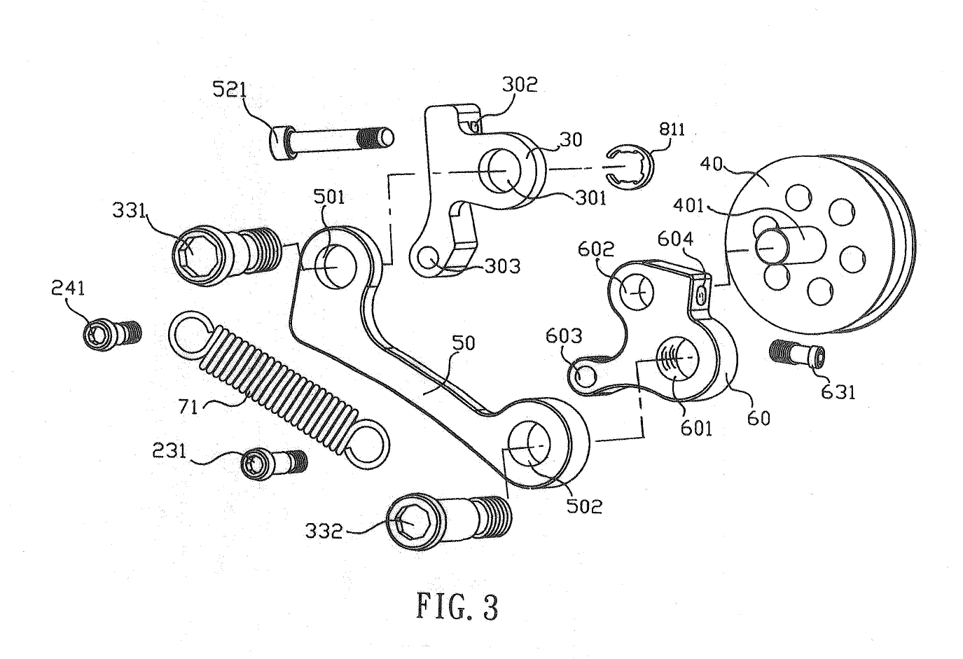

Referring to FIGS. 2 and 3, the mechanism for adjusting tension of a belt of a bicycle of the present invention comprises a link 50 which is pivotably connected between am arm 30 and a frame 60. A securing bolt 331 extends through the circular hole 501 in one end of the link 50 and the circular hole 301 in the arm 30, and then is secured by an E-clip 811 as shown in FIG. 3. Another securing bolt 332 extends through the circular hole 502 in the other end of the link 50 and the threaded hole 601 in the frame 60, so that the frame 60 is pivotable relative to the link 50. The frame 60 has another circular hole 602 and the guide wheel 40 has a shaft 401 extending centrally from one side thereof. The shaft 401 extends through the circular hole 602 of the frame 60 and is mounted to the shaft 401. A fixing bolt 631 extends through the threaded hole 604 of the frame 60 and contacts against the shaft 401 of the guide wheel 40 so as to adjust the angular position of the guide wheel 40 on the frame 60. The extension spring 71 is connected between the arm 30 and the frame 60 by using the two respective spring securing bolts 231, 241 to be connected to the threaded hole 603 of the frame 60 and the threaded hole 303 of the arm 30. The link 50, the arm 30, the extension spring 71 and the frame 60 form a four-link mechanism. The arm 30 has a tension adjustment bolt 521 threadedly extending through the threaded hole 302 in one end thereof.

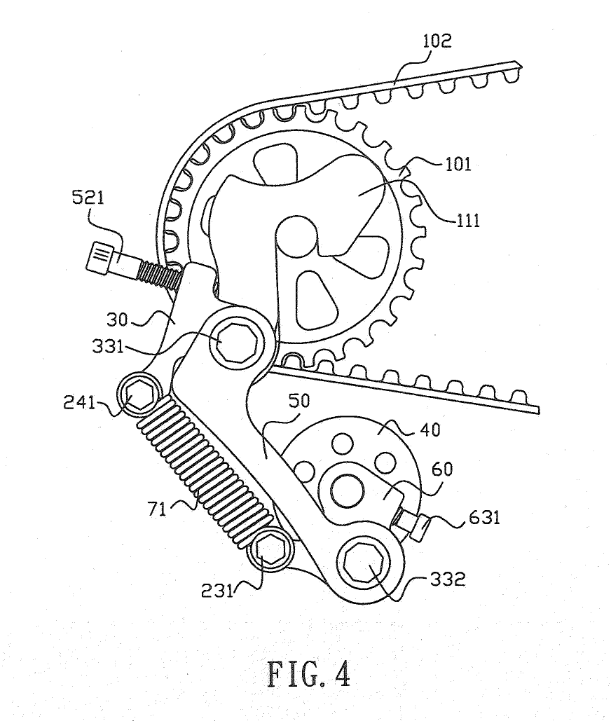

As shown in FIG. 4, the mechanism of the present invention is installed to the dropouts 111 of the bicycle by the securing bolt 331. The mechanism of the present invention is pivotable relative to the dropouts 111 so that when the mechanism is pivoted due to the gravity until the tension adjustment bolt 521 contacts the dropouts 111, the mechanism of the present invention is positioned at the proper position. Because the notch of the dropouts 111 faces downward, so that the position of the mechanism of the present invention is convenient for replacement of the rear gear set 101 and the belt 102.

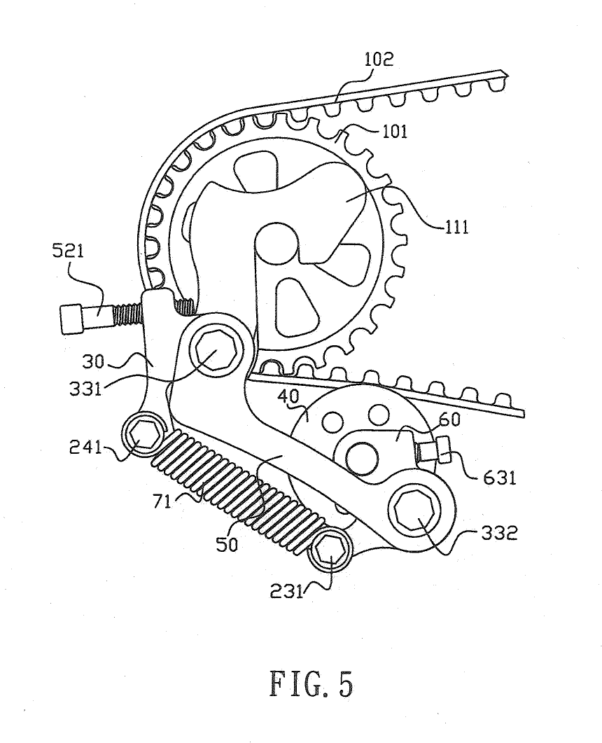

As shown in FIG. 5, when the tension adjustment bolt 521 is moved into the threaded hole 302 of the arm 30, the tension adjustment bolt 521 pushes the dropouts 111 so that the arm 30 is pivoted counter clockwise about the securing bolt 331. The movement of the arm 30 drives the link 50 to pivot counter clockwise. When the link 50 is pivoted counter clockwise, the guide wheel 40 contacts the belt 102. When the tension adjustment bolt 521 is continuously moved into the threaded hole 302 of the arm 30, the guide wheel 40 receives a reaction force from the belt 102 and is pivoted counter clockwise about the securing bolt 332 to extend the extension spring 71. The deformation of the extension spring 71 apples a torque to the frame 60 and the frame 60 makes the guide wheel 40 to press onto the belt 102 to adjust the tension of the belt 102. In other words, by operation to the tension adjustment bolt 521, the tension on the belt 102 is adjusted.

The characters of the present invention is that the link 50 is pivotably connected between the arm 30 and the frame 60 by the two securing bolts 331, 332, and the extension spring 71 is connected between the arm 30 and the frame 60 by the two respective spring securing bolts 231, 241. The link 50, the arm 30, the extension spring 71 and the frame 60 form a four-link mechanism. The tension of the belt 102 can be adjusted by operation to the tension adjustment bolt 521. The guide wheel 40 is constantly in contact with the belt 102 because the frame 60 is pivoted about the securing bolt 332 so as to overcome the problem that the belt cannot precisely engaged with the gear of the bicycle due to looseness.

While I have shown and described the embodiment in accordance with the present invention, it should be clear to those skilled in the art that further embodiments may be made without departing from the scope of the present invention.

What is claimed is:

1. A mechanism for adjusting tension of a belt of a bicycle, comprising:
a link pivotably connected between an arm and a frame, the arm having a tension adjustment bolt connected to one end thereof, the frame having a guide wheel connected thereto, and
an extension spring connected between the arm and the frame.

2. The mechanism as claimed in claim 1, wherein the arm is pivotable relative to the link.

3. The mechanism as claimed in claim 1, wherein the frame is pivotable relative to the link.

4. The mechanism as claimed in claim 1, wherein the link, the arm, the extension spring and the frame form a four-link mechanism.

5. The mechanism as claimed in claim 1, wherein the guide wheel has a shaft extending centrally from one side thereof and the frame is mounted to the shaft, a fixing bolt extends through the frame and contacts against the shaft of the guide wheel so as to adjust an angular position of the guide wheel on the frame.
